(19) United States
(12) Patent Application Publication
(10) Pub. No.: US 2025/0259278 A1
(43) Pub. Date: Aug. 14, 2025

(54) SYSTEM AND METHOD FOR IMAGE NOISE REDUCTION

(71) Applicant: University of Louisiana at Lafayette, Lafayette, LA (US)

(72) Inventors: Mohammadhassan Najafi, Lafayette, LA (US); Seyedeh Newsha Estiri, Lafayette, LA (US); Amir Hossein Jalilvand, Lafayette, LA (US); Samaneh Naderi, Tehran (IR); Mahdi Fazeli, Halmstad (SE)

(73) Assignee: University of Louisiana at Lafayette, Lafayette, LA (US)

(21) Appl. No.: 18/920,946

(22) Filed: Oct. 20, 2024

Related U.S. Application Data
(60) Provisional application No. 63/544,983, filed on Oct. 20, 2023.

(51) Int. Cl. G06T 5/70; G06N 7/06

(52) U.S. Cl. CPC G06T 5/70; G06N 7/06

(57) ABSTRACT

An efficient hardware design for a fuzzy noise reduction filtering in a stochastic computing system. The filtering device and method comprises two main stages: edge detection and fuzzy smoothing. The fuzzy difference, which is encoded as bit-streams, is used to detect edges. Then, fuzzy smoothing is done to average the pixel value based on eight directions. Experimental results show a significant reduction in the hardware area and power consumption compared to the conventional binary implementation while preserving the quality of the results.

### CROSS-REFERENCE TO RELATED APPLICATIONS

This application claims priority to U.S. Provisional Application No. 63/544,983 titled “Device and Method for Stochastic Computing-Based Fuzzy Filtering for Image Noise Reduction” filed on Oct. 20, 2023.

### STATEMENT REGARDING FEDERALLY SPONSORED RESEARCH OR DEVELOPMENT

This invention was made with government support under Grant No. 2019511 awarded by the National Science Foundation. The government has certain rights in the invention.

### Reference to a “Sequence Listing,” a Table, or a Computer Program

Not applicable.

### FIELD OF THE INVENTION

The field of the invention is stochastic computing and fuzzy logic, namely image noise reduction through fuzzy filtering.

### BRIEF DESCRIPTION OF THE DRAWINGS

The drawings constitute a part of this specification and include exemplary embodiments of the invention disclosed herein, which may be embodied in various forms. It is to be understood that in some instances, various aspects of the invention may be shown exaggerated or enlarged to facilitate an understanding of the invention. Therefore, the drawings may not be to scale.

FIG. 1 is a rendering of a 3×3 neighborhood of pixel(x, y).

FIG. 2 is a high-level flow chart of the fuzzy filtering method presented herein.

FIG. 3 shows the general operation of the fuzzy filtering method as applied to a 3×3 block with the center pixel (2,2). Eight directions with their respective pixel values are illustrated.

FIG. 4 is a logic diagram of the stochastic based design of the correction

calculator disclosed.

FIG. 5 is a logic diagram of the stochastic based design of the correction accumulator disclosed.

FIG. 6 is a logic diagram of the SNG unit design, where (a1, . . . , a24) are the Δ(x,y) values calculated for pixel(x,y) and its neighboring pixels in 8 directions. The other input is the adaptive parameter Sd.

FIG. 7 is a table reporting the hardware cost comparison of the stochastic computing design as compared to a binary design. The bit-stream length for the SC designs is 2^{BW}, where BW is the Bit Width.

FIG. 8 is a table reporting the accuracy evaluation (MSE) of the disclosed stochastic computing with different bit-stream lengths (BL) and the conventional binary design.

FIG. 9 is the image used in testing of the disclosed method and design.

FIG. 10 is the same image depicted in FIG. 9 with an additive Gaussian noise variance equal to 10.

FIG. 11A is the output image after applying conventional fuzzy filtering to FIG. 9.

FIG. 11B is the output image after applying the disclosed stochastic-based fuzzy filtering method to FIG. 9.

FIG. 11C is the output image after applying median filtering (7×7) to FIG. 9.

FIG. 12 is a high level flow chart of the disclosed fuzzy filtering method.

FIG. 13 is a high-level flow chart of another embodiment of the stochastic-based fuzzy filtering process.

### BACKGROUND OF THE INVENTION

Hardware-based data processing is bounded by some strict design constraints such as low power consumption, small circuit area, and reliability. Power and area costs are of particular concern in designing embedded systems. Weighted binary radix has been the dominant format for the representation of data in these systems. Computation on this representation is rather complex and hence costly as each bit has its own weight according to its position. Considering the complexity of conventional binary designs, unconventional design techniques are receiving more and more attention.

Stochastic computing (SC) is an unconventional computing paradigm operating on random bit-streams that offers low-cost design and high tolerance to noise. In SC, numbers in the [0, 1] interval are presented using streams of random bits. Independent of the length, the ratio of the number of ones to the length of the stream determines the bit-stream value. For example, 1101011101 is a representation for 0.7 in the stochastic domain. Conventionally, to convert data from conventional binary to stochastic representation, a random number from a random number source is compared with a constant number (i.e., the input data). The output of this comparison produces one bit of the bit-stream. For an N-bit bit-stream, the input number is compared with N random numbers. Implementing complex operations with simple hardware and the ability to tolerate high rates of noise are the primary advantages of SC.

Complex arithmetic operations can be implemented using simple logic gates in SC. For example, multiplication operation can be performed using a single AND gate fed with uncorrelated (independent) bit-streams. This provides a significantly lower hardware cost compared to conventional binary multiplication. SC has been used for implementing low-cost designs for different application domains, including but not limited to image and video processing to sound processing, neural networks, and sorting.

Minimum and maximum operations, for example, are two operations widely used in the fuzzy system with simple implementation in the stochastic domain. Fuzzy logic allows for analysis where data is fuzzy or unclear. The minimum/maximum operation is implemented with a single AND/OR gate when fed with two correlated bit-streams, i.e., two bit-streams with a maximum overlap in the position of ones. The conventional binary implementation of these operations, however, requires an n-bit comparator and an n-bit multiplexer (MUX). This results in a higher hardware area and power cost with the binary implementation. SC-based designs are independent of the precision of data; the same design can process input data with higher precision by processing longer bit-streams.

Conventionally, pseudo-random number generators are used in SC systems to convert data from binary to stochastic bit-streams. Recently, quasi-random number generators, such as Sobol and Halton sequence generators, have been used to generate high-quality low discrepancy (LD) bit-streams. LD bit-streams provide higher accuracy with significantly shorter bit-streams compared to conventional pseudo-random bit-streams. 1s and 0s are uniformly spaced in LD bit-streams, so the bit-streams do not suffer from the random fluctuations error. The bit-streams converge faster to the expected results, resulting in a lower processing time and energy consumption.

Noise reduction with feature preservation is a fundamental problem in image processing. One of the main types of noise is additive noise. This noise is defined when a value with a specific distribution (e.g., Gaussian distribution) is added to each image pixel. The fuzzy filter of this work aims to remove the additive noise from input images. In contrast to the mean and median filter-based noise reduction techniques, which result in loss of edge information, the selected filter can preserve edge information and details of the image. The first stage for processing each image pixel is to compute a fuzzy derivative. A set of 16 fuzzy rules is then fired to determine a correction term for the processed pixel value. These rules use the fuzzy derivative as input.

### SUMMARY OF THE INVENTION

The design applies the concept of SC to fuzzy logic-based filtering for image noise reduction. In contrast to the two-valued logic in the binary sets (true or false), fuzzy-logic variables have truth values in the [0, 1] interval, the acceptable range of data in SC. Fuzzy filtering is used to reduce notice in the images while preserving important structural details, such as edges. Unlike conventional filtering like mean and median filtering, which can often blur important image features—fuzzy filtering uses fuzzy logic to intelligently determine the amount of smoothing required for each pixel based on its local neighborhood.

In image processing, preserving edges is crucial because edges represent boundaries between different objects or textures in an image. Traditional filters known in the art apply uniform smoothing across the image, which tends to weaken or blur the edges, leading to a loss of detail and reduced image quality. Fuzzy filters overcome this limitation by making context-aware each decision for each pixel based on the surrounding pixels.

The disclosed method comprises the following steps: (1) fuzzy derivatives calculation, where the intensity differences between a pixel and its neighbors are calculated in all eight directions; (2) membership function, where the fuzzy membership function maps the derivatives into fuzzy values, indicating how likely the pixel is to belong to an edge or a smooth region; (3) fuzzy rules, where based on the member values, a set of fuzzy rules is applied to determine the amount of noise reduction to be applied to the pixel; and (4) correction calculation, where a correct term is calculated for a pixel, which will adjust its intensity to reduce noise while preserving edge details.

The design comprises a low-cost hardware design for a fuzzy noise reduction filter based on stochastic computing. The design distinguishes between local variations due to noise and to image structures such as edges. Synthesis results confirm the efficiency of the proposed design. The stochastic-based design provides significant saving in the hardware area and power costs compared to the conventional binary implementation while preserving the quality of the results.

Here, stochastic computing is applied for hardware-efficient design of fuzzy filtering image noise reduction. The disclosed design estimates a fuzzy derivative to distinguish between local variations due to noise and image structure. This SC design comprises state-of-the-art low-discrepancy (LD) bit-streams for low-latency yet high accuracy processing. The synthesis results show a significant reduction in the hardware area, power, and energy consumption compared to the conventional binary implementation.

Disclosed herein is a computer program product comprising a computer readable medium having instructions recorded thereon, the instructions when executed by a computer implementing a method as described herein.

Disclosed herein is a non-transitory computer-readable medium having values of a stochastic variation at a plurality of conditions.

### DETAILED DESCRIPTION OF THE INVENTION

The design uses Sobol sequences to generate LD bit-streams. The first 2^{N} numbers of any Sobol sequence can precisely present all possible N-bit precision numbers in the [0,1] interval. Hence, the only error in converting an N-bit precision data to a 2^{N} Sobol-based LD bit-stream is the quantization error. For a lower bit-stream generation cost compared to conventional comparator-based LD bit-stream generator that requires a costly Sobol sequence generator, the design use the finite-state machine (FSM)-based LD bit-stream generator to generate Sobol-based LD bit-streams.

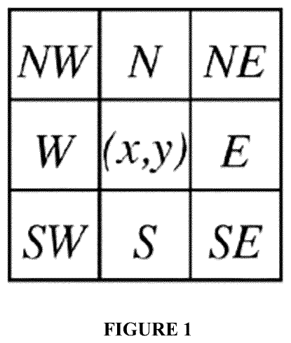

Small, negative and positive membership functions are used in the disclosed fuzzy filter. The small membership function can be adapted for more iterations of noise reduction. In this approach, detecting the edges near the target pixel is the first step in removing noise. Consider a 3×3 neighborhood of pixel(x, y) as shown in FIG. 1. The derivative in direction D (D∈dir={NW, W, SW, S, SE, E, NE, N}) is defined as the difference between pixel(x, y) and its neighbor in the D direction. This derivative value is denoted by Δ_{D} (x, y).

The fuzzy filtering process may consist of the following key steps: (1) neighborhood-based analysis, (2) fuzzy derivative calculation, and (3) fuzzy logic and membership functions. For neighborhood-based analysis, for each pixel in the image, a local neighborhood (typically a 3×3 window) is considered. The neighborhood may consist of the pixel's immediate neighbors all in eight directions: North (N), South (S), East (E), West (W), Northeast (NE), Northwest (NW), Southeast (SE), and Southwest (SW). There, the center pixel can be compared with its neighboring pixels to assess whether it lies in a smooth region (where pixel values are relatively uniform) or an edge region (where pixel values change sharply, indicating the presence of a boundary). In fuzzy derivative calculations, the differences between the center pixel and its neighbors in all eight directions can be calculated. These differences are called fuzzy derivatives and are used to quantify how much the pixel values change in each direction. If the derivative in a direction is small, the pixel likely belongs to a smooth region. If the derivative is large, it indicates the presence of an edge in that direction. For the fuzzy logic and membership functions, fuzzy logic is employed to handle the uncertainty and imprecision in determining whether a pixel belongs to an edge or smooth region. Unlike traditional logic, which would classify a pixel as either an edge or not, fuzzy logic allows for partial membership in multiple categories. In other words, a pixel can be somewhat part of an edge and somewhat part of a smooth region, depending on derivative values. A fuzzy membership function is then used to map the fuzzy derivatives into values that indicate the likelihood of a pixel being part of an edge or a smooth region. The membership function assigns a value between 0 and 1: (a) if the derivative is small, the membership function assigns a value close to 1, indicating that the pixel is in a smooth region; (b) if the derivative is large, the membership function assigns a value close to 0, indicating that the pixel is likely part of an edge.

In one embodiment—consider an edge passing through the neighborhood of a pixel(x, y) in the SW-NE direction. Because it is an edge, the derivative value Δ_{NW}(x, y) will be large, but also the derivative values of the neighboring pixels perpendicular to the edge's direction can be large. For example, in the NW direction, we can calculate Δ_{NW}(x, y), Δ_{NW}(x−1, y +1), and Δ_{NW}(x+1, y−1). The idea is to reduce the effect of one derivative value, which is high due to noise. Therefore, if two out of three derivative values are small, one can assume that no edge is present in this direction. This determination will be considered when we formulate the fuzzy rule to calculate the fuzzy derivative values. Defined is the following membership function:

$$m ( a ) = \{ \begin{matrix}1 - \frac{\vert a \vert}{Sd} , & 0 \leq a \leq Sd \\ 0 , & \vert a \vert > Sd\end{matrix} \qquad ( 1 )$$

where Sd is an adaptive parameter. For example, the value of the fuzzy derivative Δ_{NW}^{F}(x, y) for pixel (x, y) in the NW-direction is calculated by applying the following rules:
if (Δ_{NW}(x, y) is small and Δ_{NW}(x−1, y+1)is small)
or (Δ_{NW}(x, y) is small and Δ_{NW}(x+1, y−1)is small)
or (Δ_{NW}(x-1, y +1) is small and Δ_{NW}(x+1, y−1)is small)
then Δ_{NW}^{F}(x, y) is small.

Sd determines the spread of the small membership function and ultimately the threshold for edge detection. Instead of sampling the whole image for standard deviation, take k×k blocks of the image and find their standard deviation. Then take the minimum standard deviation across all blocks. In one embodiment, K=6 for improved efficiency. The minimum deviation Sd will always be less than the deviation in case of an edge. Finally, multiply the standard deviation by an amplification parameter (a) to increase noise reduction:

$$Sd = α \times standard deviation \qquad ( 2 )$$

Once derivatives are processed through the membership function, the fuzzy filtering method applies a set of fuzzy rules to determine the appropriate correction for the pixel. These rules are based on the magnitudes of the derivatives and the fuzzy membership values. The fuzzy rules follow an if-then structure, which enables the system to make context aware decisions about how much smoothing should be applied to the pixel. The fuzzy rules enable the filter to adapt its behavior depending on the context of the pixel, ensuring that the edges are preserved while noise in smooth areas is reduced.

One rule may be formed for when the majority of the derivatives are small (smooth region). In this case, this would indicate the pixel is surrounded by similar intensity values, suggesting that it is in a flat or smooth area of the image. In such cases, the pixel is likely affected by noise rathe than edges. So, the rule could be in this instance: “if most derivatives are small, apply strong noise reduction.” Thus, the action would then be to apply a stronger connection to the pixel value to reduce noise.

Another rule may be formed for when most of the derivatives are large (edge region). In this instance, this would indicate the pixel lies on an edge, where intensity values change sharply between neighboring pixels. To preserve the integrity of the edge, the system should avoid excessive smoothing. So, the rule could be in this instance: “If most derivatives are large, apply minimal correction.” Thus, the system applies little to no correction to preserve the edge detail.

Another rule may be formed when the derivatives are mixed (intermediate region). In this case, it would indicate that the pixel lies near an edge, so the derivatives will be a mix of small and large values. Here, the system needs to balance noise reduction with edge preservation. So, the rule could be in this instance “if some derivatives are small and some are large, apply moderate correction.” Thus, the system would apply a moderate amount of smoothing to reduce noise without blurring the edge.

Consider the following embodiment—pair of fuzzy rules is used for each direction to compute the correction term for the proposed pixel value. If no edge is present in a specific direction, the derivative value in that direction can and will be used to compute the correction term. The first part (edge assumption) can be realized by using the fuzzy derivative value. For the second part (filtering), distinguish between the positive and negative values of the correction term. The following fuzzy rules can be specified to obtain the final correction for a direction:
C_{D}_{ₚ}: if Δ_{NW}(x, y) is small and Δ_{NW}(x, y) is positive, then c is positive.
C_{D}_{ₙ}: if Δ_{NW}^{F}(x, y) is small and Δ_{NW}(x, y) is negative, then c is negative.

After obtaining C_{D}_{ₚ} and C_{D}_{ₙ} for all directions, average their value to obtain the final correction:

$$Δ C ( x , y ) = {\sum }_{D ∈ directions} ( {C}_{{D}_{p}} - {C}_{{D}_{n}} ) / 8 \qquad ( 3 )$$

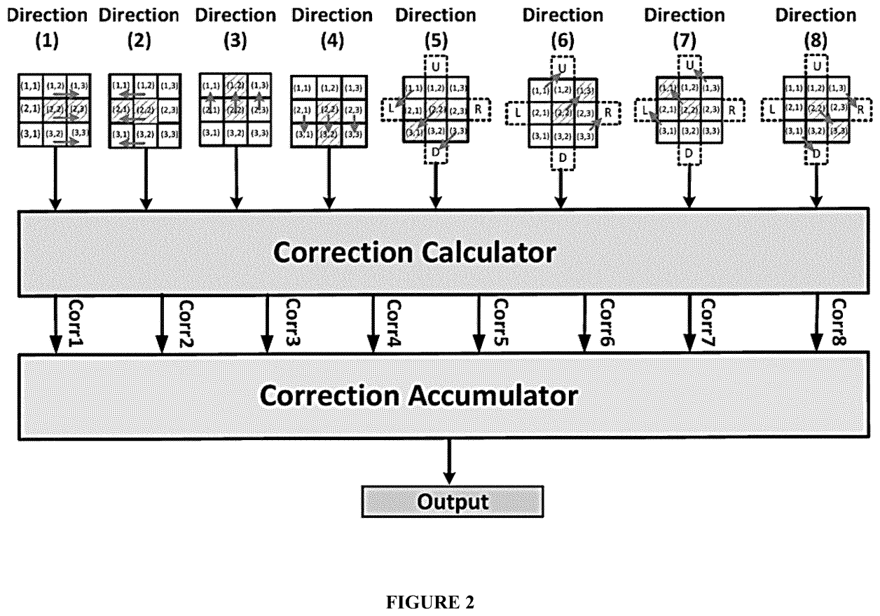

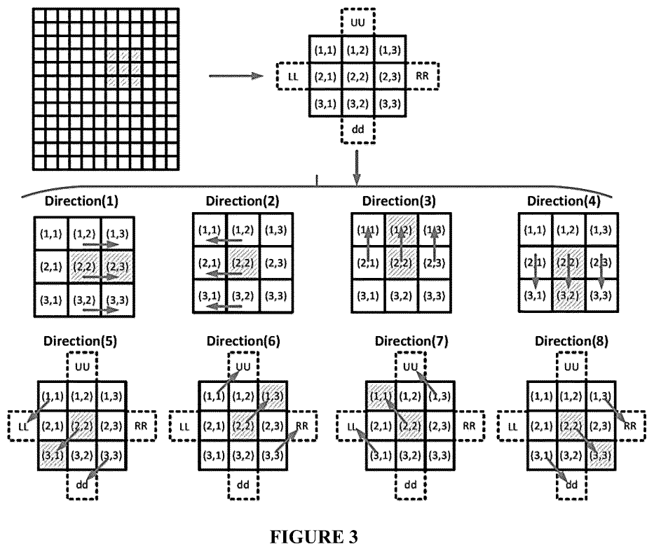

Now presented is the SC hardware architecture for the described fuzzy filtering noise reduction method. As shown in FIG. 2, the design consists of two main parts: (1) correction calculator and (2) correction accumulator. In one embodiment, a 3×3 block window is considered. For each center pixel, the correction value is calculated in eight directions. FIG. 3 shows an example of a 3×3 block window with eight directions. The calculated correction values of each direction are summed up together and the produced result will be added to the input pixel value.

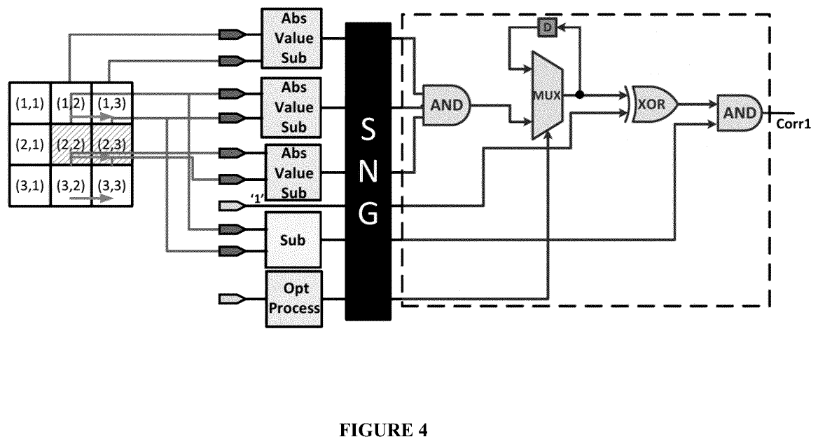

Correction Calculator. FIG. 4 shows the stochastic-based design for a correction calculator. The correction calculation may compute the fuzzy correction values for each pixel based on the derivatives in eight directions, as described in the method discussion above. The fuzzy logic operations, such as computing the minimum, maximum, and performing multiplication are carried out using stochastic computing components. In the stochastic computing-based design shown in FIG. 4, stochastic bit-streams are generated for each pixel and its neighbors. The bit-streams represent the derivatives between the pixel and its neighbors, as well as the results of the fuzzy membership function. These stochastic bit-streams are processed using simple SC circuits. Each fuzzy rule requires operations like multiplication (to combine fuzzy membership values), minimum or maximum selection (to choose the smallest or largest value, depending on the fuzzy rule), and addition (to sum up correction values).

As shown in FIG. 4, the stochastic-based design for a correction calculator may comprise: an input for each direction of a pixel (for FIG. 4, it is 8 directions), multiple absolute value subtractors, at least one subtractor, and an opt process block, wherein the subtractors and opt process block respective outputs serve as inputs for a stochastic number generator (SNG) unit. The disclosed correction calculator may further comprise at least two AND gates, an XOR gate, a D gate, and a multiplexor.

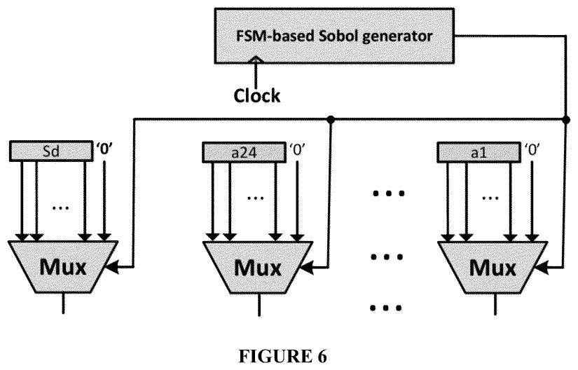

In operation, the input values (Δ(x,y) values for eight directions) are first converted to stochastic bit-streams using a SNG. FIG. 6 shows the structure of the SNG unit. The SNG unit may comprise a clock input, an input for the SNG unit, an FSM-based Sobol generator, and a plurality of multiplexors. The inputs for the SNG unit may be converted to Sobol-based LD bit-streams using the FSM-based bit-stream generator, though one having skill in the art will recognize that there are other methods that can be used to convert the inputs. One FSM is shared for converting all inputs to the SNG. However, each input to the SNG is connected to a different MUX unit. Considering a 3×3 block window, the calculator computes the fuzzy derivative values for eight directions. An embodiment of the calculator further comprises an adaptive parameter, Sd. So, in total, for a 3×3 block window 3×8+1=25 MUX units are needed in the SNG unit. The fuzzy rule, a min-based function, is in an embodiment implemented using a standard AND gate. This use of a single AND gate to perform multiplication is a key advantage of the disclosed design because conventional binary arithmetic requires much more complex hardware.

Per Equation 1, the small membership function consists of a division, a comparator, and a subtraction unit. The design comprises an SC division circuit to perform division, which in one embodiment comprises a correlated divider (CORDIV), which implements stochastic division by generating a bit-stream output that represents the quotient of two input bit-streams. A CORDIV can provide lower hardware costs and higher accuracy. Unlike conventional binary correction calculators, an SC-based calculator does not require a comparator unit since the values are in the [0,1] integral. In one embodiment, subtraction is implemented with a standard OR-gate in the stochastic design. The calculator circuit then performs multiplication. As shown by Equation 2, the final result is the correction component of D and is a fraction of Δ(x,y). Comparisons (e.g., finding the minimum value) are implemented using simple stochastic logic, allowing the circuit to choose the correct correction value efficiently. Once the fuzzy rules are evaluated in the stochastic domain, the correction values may be calculated and passed on to the next stage in the design-the stochastic correction accumulator.

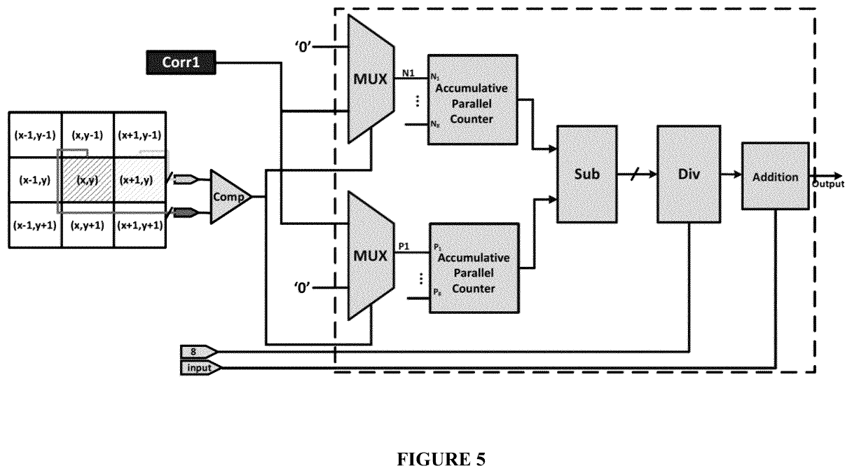

Correction Accumulator. The correction accumulator may be responsible for aggregating the correction values from all eight directions (N, S, E, W, NE, NW, SE, SW). This step involves summing the correction values and adjusting the pixel's intensity accordingly. In the SC-based design, the accumulator handles positive and negative correction values separately to ensure that edge information is preserved while noise is reduced. FIG. 5 presents the SC-based correction accumulator design, where correction values are represented as stochastic bit-streams and processed using stochastic adders and subtractors. As seen in FIG. 5, the accumulator design comprises the stochastic correction calculator's output as an input, a comparator, at least two multiplexors, at least two accumulative parallel counters, a stochastic subtractor, a stochastic divider, a stochastic adder, and an output.

In an embodiment, after calculating the correction values of all directions, the system may average their value to obtain the final correction value. The final value result is then added to the pixel value. The correction values of each direction are either positive or negative depending on the sign of the Δ(x,y) value of the direction. In one embodiment, negative data is handled in the stochastic domain by extending the range of numbers from [0,1] to [−1,1] using linear transformation in a bipolar encoding. Bipolar SC, however, requires twice bit-stream length and so twice processing time for the same accuracy compared to stochastic unipolar encoding. Instead, the design may divide the correction values into positive and negative subsets to handle negative correction values in the stochastic-based correction accumulator. This ensures that edge preservation is prioritized, as large corrections in the positive direction (indicative of smooth areas) are balanced against smaller negative corrections (indicative of edges). As shown in FIG. 5, a comparator is used to determine the sign of Δ(x,y). For example, if the value of pixel (x+1,y) is greater than the value of pixel(x,y), ΔE (x,y) and so the correction value are positive. In one embodiment of the accumulation step (Accumulative Parallel Counter (APC)), the correction values in the “positive” subset and the “negative” subset are accumulated separately using binary adders, implicitly converting them from bit-stream to binary representation. In this stochastic design, the positive and negative corrections may be summed using stochastic adders, and the final correction value is obtained by subtracting the sum of the negative corrections from the sum of the positive corrections. This subtraction is performed in the stochastic domain using stochastic subtraction circuits. The outputs of the two APC units are then subtracted from each other. In the last step, the final correction value is divided by eight (because there are 8 directions) to compute the average correction for the pixel and is added to the original input pixel. This ensures that the correction is distributed evenly across all directions.

A key challenge in stochastic computing is generating high-quality bit-streams that accurately represent the input values. To address this, the disclosed SC-based design uses low-discrepancy sequences (LD sequences), specifically Sobol sequences, to generate bit-streams. Sobol sequences are a type of quasi-random sequence that ensures that the bit-streams converge to the desired value more quickly than purely random bit-streams. By using Sobol sequences, the design is able to reduce the length of the bit-streams while maintaining a high level of accuracy, further reducing hardware area and power consumption.

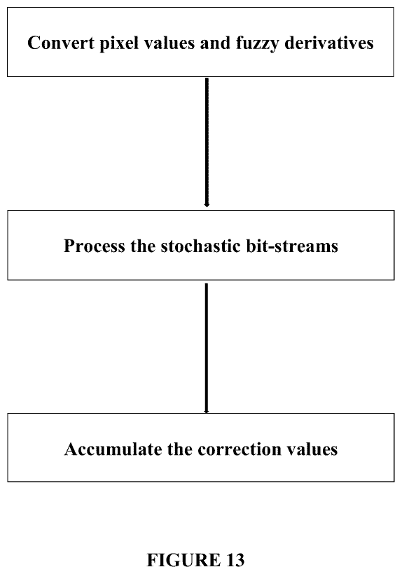

To summarize the stochastic-based fuzzy filtering process, outlined in the flowchart in FIG. 13, the following steps may be performed: (1) convert pixels and fuzzy derivatives into stochastic bit-streams using the FSM-controlled Sobol sequence generator; (2) process the stochastic bit-streams through the correction calculator, which applies fuzzy rules and performs operations like multiplication and division using simple SC circuits (AND gates and CORDIV); and (3) accumulate the correction values in the correction accumulator, separating the positive and negative values, and then applying the final correction to the pixel. The key advantage of the SC-based design is that it performs all these operations with significantly reduced hardware complexity.

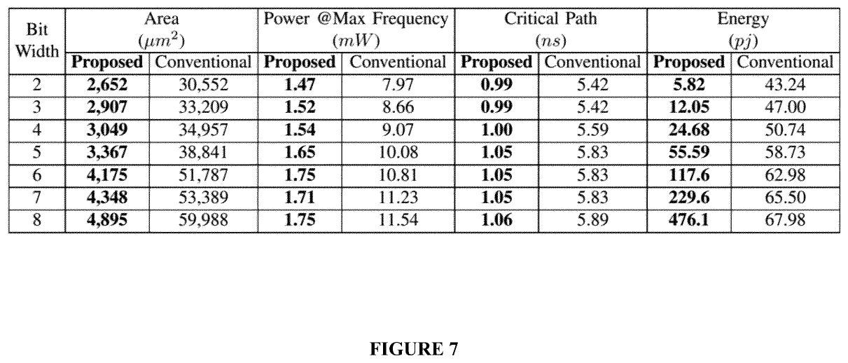

The hardware cost and performance of the disclosed design is now evaluated. For hardware cost comparison, RTL VHDL descriptions were developed for the proposed SC-based and the conventional binary design. The designs were synthesized, and the inventors report the synthesis results for different data bit-widths (i.e., M=2, 3, 4, 5, 6, 7, and 8). FIG. 7 reports the synthesis results in terms of hardware footprint area, power consumption at maximum working frequency, critical path latency, and energy consumption. The energy consumption of the proposed design is calculated by finding power×critical path latency×number of clock cycles. As it can be seen in FIG. 7, the proposed design achieves up to 91.8% savings in the hardware area and 84.7% reduction in power consumption. The proposed design achieves a lower area and power cost for all data bit-widths. However, in terms of energy consumption, the proposed design provides lower energy for bit-widths less than six. The energy saving rate decreases by increasing the data-width as the number of processing cycles in the proposed design increases by increasing the precision of data.

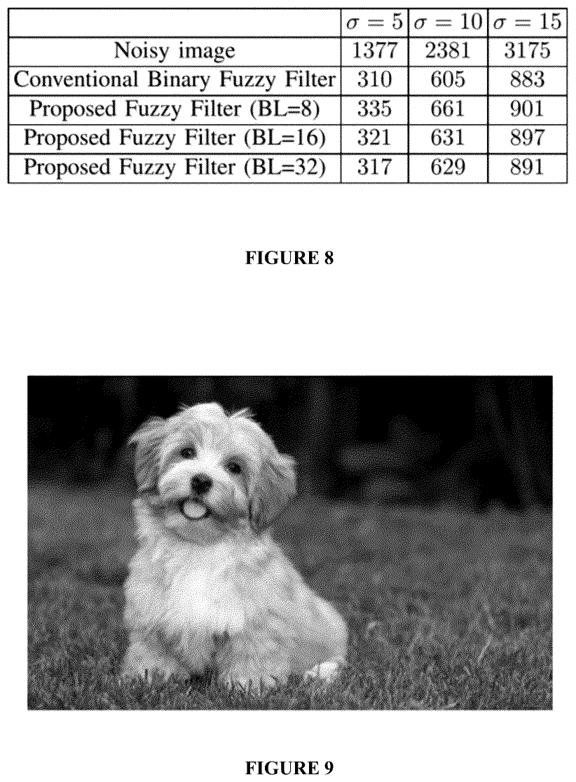

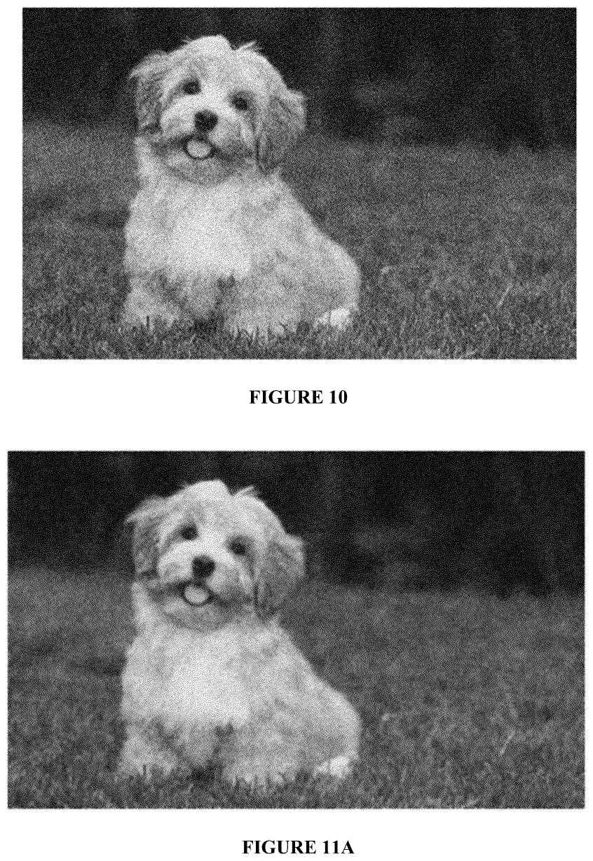

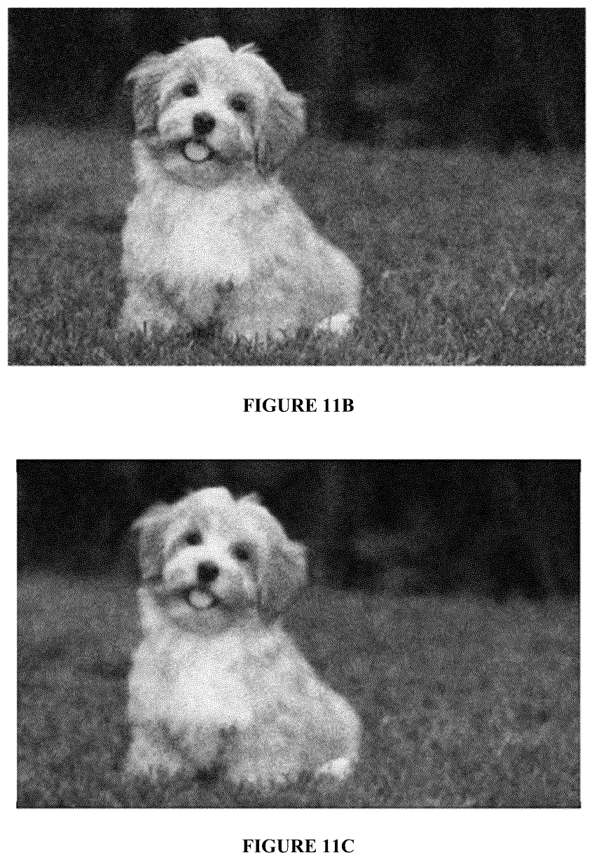

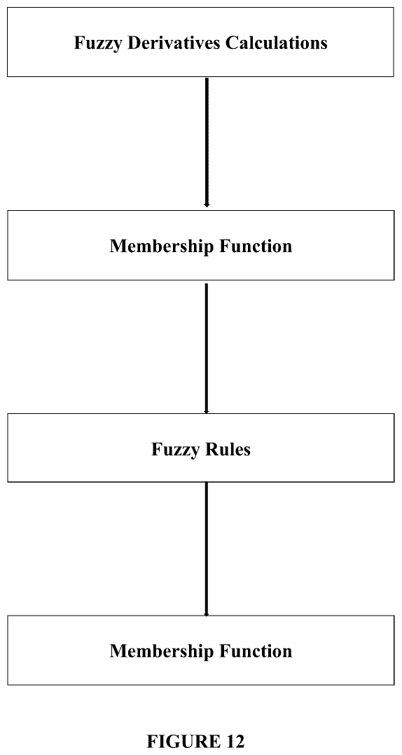

The fixed-point baseline design and the proposed bit-stream-based design were evaluated for accuracy. Both approaches were evaluated with a test image after adding different levels of Gaussian noise. FIG. 9 shows the representative test image. The image was corrupted in testing with the variance of Gaussian noise equal to 5, 10, and 15. To evaluate the results, calculate the mean squared error (MSE) between the original image and the filtered image. For high noise levels, more iterations were needed to reach an MSE close to the median filter. However, one or two iterations provides an acceptable noise reduction for low noise levels. For more noise reduction, increase the amplification a factor. FIG. 8 reports the MSE results. For the variance equal to 5, both the baseline and proposed stochastic filters are applied in only one iteration. Three iterations are done to achieve a lower MSE for the variance of Gaussian noise equal to 10 and 15. The proposed SC fuzzy filter design performs as well as the conventional binary-based fuzzy filter. The MSE obtained from the proposed design is negligibly higher than the baseline design, mainly due to the quantization errors. FIG. 10 shows the dog image with noise var=10. A 7×7 Median filter and the fuzzy filter in stochastic and binary domains are applied to the noisy image. As seen in FIG. 11C, the median filter was unable to preserve the image's details, such as the grass, the border of the dog body and the image background is blurred. However, both designs of the fuzzy filter seen in FIGS. 11A and 11B were able to keep the small details, and the output is sharper.

The subject matter of the present invention is described with specificity herein to meet statutory requirements. However, the description itself is not intended to necessarily limit the scope of claims. Rather, the claimed subject matter might be embodied in other ways to include different steps or combinations of steps like the ones described in this document, in conjunction with other present or future technologies. Although the terms “step” and/or “block” or “module” etc. might be used herein to connote different components of methods or systems employed, the terms should not be interpreted as implying any specific order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

We claim:

1. A system comprising:
at least one circuit comprising
configuration to:
receive and store an input image in computer-readable recording medium, wherein:
the input image is comprised of a plurality of pixels; and
wherein the plurality of pixels are organized in a square formation with at least one pixel comprising a center of the square formation of pixels (a center pixel);
for each pixel other than the at least one pixel comprising the center pixel of the square formation (each a neighboring pixel), compare a value of each neighboring pixel to a value of the center pixel;
for each neighboring pixel, calculate a fuzzy derivative;
for each fuzzy derivative, map the fuzzy derivative to a value between 0 to 1 to indicate a likelihood of the pixel being part of an edge region of the input image;
apply noise reduction to the center pixel if most of the fuzzy derivatives are close to 1;
apply minimal correction to the center pixel if most of the fuzzy derivatives are close to 0; and
apply moderate correction to the center pixel if the fuzzy derivatives vary in value;
a stochastic correction calculator; and
a stochastic correction accumulator.

2. The system of claim 1, wherein the plurality of pixels comprises a 3×3 window comprising 9 pixel values.

3. The system of claim 1, wherein the fuzzy derivatives are calculated by, for each neighboring pixel, determining a difference between the center pixel value and the respective neighboring pixel value.

4. The system of claim 1, wherein:
the pixels are determined to lie in a smooth region of the input image if the fuzzy derivative is small; and
the pixels are determined to lie in an edge region of the input image if the pixel values are large.

5. The system of claim 1, wherein the stochastic correction calculator comprises:
at least one absolute value subtractor unit, each comprising at least two inputs and an output;
at least one subtractor unit, comprising at least two inputs and an output;
a stochastic number generator;
a plurality of AND gates;
a D gate;
an XOR gate;
a multiplexor; and
an output.

6. The system of claim 1, wherein the stochastic correction calculator comprises:
at least one absolute value subtractor unit, each comprising at least two inputs and an output;
at least one subtractor unit, comprising at least two inputs and an output;
a stochastic number generator, wherein the outputs of the at least one subtractor unit and the at least one absolute value subtractor unit comprise inputs to the stochastic number generator;
a plurality of AND gates;
a D gate;
an XOR gate; and
a multiplexor.

7. The system of claim 1, wherein the output of the stochastic correction calculator comprises an input to the stochastic correction accumulator.

8. The system of claim 1, wherein the stochastic correction calculator comprises:
at least one absolute value subtractor unit, each comprising at least two inputs and an output;
at least one subtractor unit, comprising at least two inputs and an output;
a stochastic number generator, comprising configuration to convert the input image pixel values to stochastic bit streams;
a plurality of AND gates;
a D gate;
an XOR gate;
a multiplexor; and
an output.

9. The system of claim 1, wherein the stochastic correction calculator comprises:
at least one absolute value subtractor unit, each comprising at least two inputs and an output;
at least one subtractor unit, comprising at least two inputs and an output;
a stochastic number generator, comprising:
configuration to convert the input image pixel values to stochastic bit streams;
a clock input;
at least one input;
a finite state machine-based Sobol generator; and
plurality of multiplexers.
a plurality of AND gates;
a D gate;
an XOR gate;
a multiplexor; and
an output.

10. The system of claim 1, wherein the stochastic correction accumulator comprises:
an input, comprising an output of the stochastic correction calculator;
a comparator;
at least two multiplexors;
at least two accumulative parallel counters;
a stochastic subtractor;
a stochastic divider;
a stochastic adder; and
an output.

11. The system of claim 1, wherein the stochastic correction accumulator comprises:
an input, comprising an output of the stochastic correction calculator;
a comparator;
at least two multiplexors;
at least two accumulative parallel counters;
a stochastic subtractor;
a correlated divider;
a stochastic adder;
an output; and
configuration to:
accumulate each correction value for each pixel;
separate the correction values into positive and negative values;
apply a final correction to each pixel.

12. A method for noise reduction in images comprising:
receiving and storing an input image in computer-readable recording medium, wherein:
the input image is comprised of a plurality of pixels; and
wherein the plurality of pixels are organized in a square formation with at least one pixel comprising a center of the square formation of pixels (a center pixel);
for each pixel other than the at least one pixel comprising the center pixel of the square formation (each a neighboring pixel), comparing a value of each neighboring pixel to a value of the center pixel;
for each neighboring pixel, calculating a fuzzy derivative;
for each fuzzy derivative, mapping the fuzzy derivative to a value between 0 to 1 to indicate a likelihood of the pixel being part of an edge region of the input image;
applying noise reduction to the center pixel if most of the fuzzy derivatives are close to 1;
applying minimal correction to the center pixel if most of the fuzzy derivatives are close to 0;
applying moderate correction to the center pixel if the fuzzy derivatives vary in value;
repeating the above steps for each pixel of the input image to produce an output image; and
storing the output image in the computer-readable recording medium.

13. The method of claim 12, wherein the method is performed using an electronic device comprising a stochastic correction accumulator and a stochastic correction calculator.

14. The method of claim 12, further comprising creating a fuzzy rule by applying a membership function, comprising:
$$m ( a ) = \{ \begin{matrix}1 - \frac{\vert a \vert}{Sd} , & 0 \leq a \leq Sd \\ 0 , & \vert a \vert > Sd\end{matrix}$$
wherein Sd comprises an adaptive parameter for threshold edge detection.

15. The method of claim 12, wherein calculating a fuzzy derivative comprises generating a stochastic bit-streams by a stochastic correction calculator, comprising a stochastic number generator.

16. The method of claim 12, wherein:
calculating a fuzzy derivative comprises generating a stochastic bit-streams by a stochastic correction calculator, comprising a stochastic number generator; and
the stochastic number generator comprises:
a clock input;
a stochastic number generator input;
a finite state machine-based Sobol generator; and
a plurality of multiplexors.

17. The method of claim 12,
wherein calculating a fuzzy derivative comprises generating a stochastic bit-streams by a stochastic correction calculator; and
further comprising identifying each correction value for each pixel; and
inputting the correction values to a stochastic correction accumulator.

18. The method of claim 17, further comprising:
aggregating the correction values by the stochastic correction accumulator;
separating the correction values according to their respective polarity;
subtracting a sum of the negative correction values from the sum of the positive correction values;
combining the negative correction values sum and the positive corrections values sum to obtain a correction values total;
dividing the correction values total by the total number of neighboring pixels; and
adding the final correction value to the value of the central pixel.
